(19) United States
(12) Patent Application Publication
(10) Pub. No.: US 2017/0360051 A1
(43) Pub. Date: Dec. 21, 2017

(54) LOW-FAT FRIED PRODUCT AND METHOD FOR PRODUCING SAME

(71) Applicant: Roquette Freres, Lestrem (FR)

(72) Inventors: Thomas Boursier, Mons En Baroeul (FR); Marie Delebarre, La Couture (FR); Anne-Sophie Vercruysse, Lille (FR)

(73) Assignee: Roquette Freres, Lestrem (FR)

(21) Appl. No.: 15/537,307

(22) PCT Filed: Dec. 17, 2015
(86) PCT No.: PCT/FR2015/053564

§ 371 Date: Jun. 16, 2017

(30) Foreign Application Priority Data
Dec. 18, 2014 (FR) 1462697

(51) Int. Cl. A21D 2/08; A21D 13/066; A23L 17/60; A23L 29/00; A23L 5/10; A21D 13/60; A21D 2/18

(52) U.S. Cl. CPC A21D 2/08; A21D 13/60; A21D 13/066; A21D 2/181; A23L 29/065; A23L 5/11; A23L 17/60; A23V 2002/00

(57) ABSTRACT

The present invention concerns a fried product. More specifically, the invention relates to a fried product obtained from a composition comprising flour, yeast, microalgal flour and a drinkable liquid and having a low fat content relative to the standard composition of said fried product.

The invention also relates to the method for producing said fried products.

### FIELD OF THE INVENTION

The present invention concerns a fried product. More specifically, the invention relates to a fried product obtained by cooking a composition comprising flour, a drinkable liquid, yeast and microalgal flour and having a low fat content relative to the standard composition of said fried product.

The invention also concerns the method for producing such a fried product.

### TECHNOLOGICAL BACKGROUND

The French word “beignet” [donut] is a diminutive of the French word “beigne” which dates from XIII^{th} century France, where it denoted a ball of dough fried in butter. The swelling of the dough during cooking gave, in the figurative sense, the current meaning of the French slang word ““beigne”: bump following a slap”.

Donuts belong to the fried products prepared from a soft dough fried in oil. They are generally sweet but can also be savory. They can be plain or else can be filled with jelly, chocolate, confectioner's custard, Chantilly cream, foie gras, savory mousses, etc.

More generally, other products are found in this category of products, for instance donuts, churros, round donuts, Dutch donuts, sugar-covered fritters, tempura, etc. Each region, and more generally each country, has its own names to denote fried products of this type.

Donuts are very popular in North America. The most common version is the ring form, with a relatively dense texture, often covered with icing, which was made popular in the 1950s by certain fast food chains. The donut has been made popular outside North America by the animated series “The Simpsons”, Homer Simpson being rather partial to donuts.

The method for preparing donuts and homologs consists in preparing a soft dough, and in shaping it and then immersing it in an oil bath. Once they have been cooked, the donuts can be dusted with sugar, glazed, iced with melted sugar.

By their nature, donuts are often rich in simple carbohydrates and in fats, in particular saturated fats, because of the use of fats known as “shortening”, especially industrially. As it happens, public health recommendations strongly encourage limiting the consumption of sugar, of sugar-rich foods and/or of saturated fats.

Furthermore, the method for preparing them involving a frying step reinforces the calorie content and the fat content of products of this type, which are nevertheless very popular with consumers, including teenagers and young adults. This is because the frying methods introduce trans fats which are bad for the heart.

However, fats of animal and/or vegetable origin play an important role in products intended for breadmaking, patisserie and Viennese pastry-making. Not only do they reveal and carry the flavor of the final products, but they determine the result of a series of technical characteristics such as, for example, the moistness, the crunchiness or the good rich taste of a butter cake. They are known to be high in calories and, depending on their origin, not necessarily very good for the health, and yet they are impossible to do without since their dual technical and gustative role is so important, or even essential, to the final result of the product.

Furthermore, it is nevertheless necessary to consume a certain amount of fats daily in order to ensure that our body functions correctly. For example, oils and lipids provide calories and essential fatty acids which help the body to absorb liposoluble vitamins such as vitamins A, D, E and K. The type of lipid consumed is as important for the health as the amount consumed.

Consequently, it is strongly recommended to choose unsaturated lipids known to be good lipids. Consuming too many bad lipids, such as saturated lipids (shortening) and trans lipids (fried products), can cause LDL cholesterol (Low-Density Lipoprotein or “bad” cholesterol) levels to rise and HDL cholesterol (High-Density Lipoprotein or “good” cholesterol) levels to decrease. This imbalance can cause an increase in the risks of arterial hypertension, of narrowing of the arteries (atherosclerosis), of heart attack and of stroke.

Among unsaturated lipids, monounsaturated lipids and polyunsaturated lipids are distinguished. It has been demonstrated that monounsaturated fats improve blood cholesterol levels. They are found in olive oil, canola oil and peanut oil, in non-hydrogenated margarine, in avocados and in certain nuts such as walnuts, almonds, pistachios, cashew nuts, pecan nuts and hazelnuts. Polyunsaturated fats help the body to rid itself of recently produced cholesterol. Among said polyunsaturated fats are the omega-3 fats, which can prevent blood clots, reduce the risk of having a stroke and also reduce triglycerides, a type of fat in the blood linked to heart disease. The best sources of omega-3 are cold-water fish, and likewise canola and soybean oils, eggs rich in omega-3, linseeds, walnuts, pecan nuts and pine nuts. Also in this category of fats are omega-6 fats which help to reduce LDL cholesterol, but excessive consumption of which can also reduce HDL cholesterol. They should therefore be consumed in moderation. They are found in safflower, sunflower and corn oils, non-hydrogenated margarines, nuts such as almonds, pecan nuts and Brazil nuts, and sunflower seeds. Many prepared meals also contain them.

In parallel are saturated lipids, which are most commonly found in fatty meats, whole milk products, butter, lard, shortenings, coconut oil and palm oil. These fats can increase the “bad” LDL cholesterol. Just like saturated fats, trans lipids cause LDL cholesterol to increase. Trans lipids are found in partially hydrogenated margarines, fried foods from fast food outlets (fries, donuts) and in numerous crackers, cookies and commercial patisserie products.

From the aforementioned, it can be retained that fats make foods more delicious and are essential to our health. However, when consumed in excess, they can have negative effects, in particular on the cardiovascular system.

For several years, specialists have been denouncing trans fats as being even more dangerous to the health than saturated fats. According to studies, eliminating all trans-fatty acids from the diet would lead to a 20% decrease in deaths caused by cardiovascular diseases. Unfortunately, trans fats are often present in cakes, cookies, chips, donuts, margarines, fish and other prepared fried products.

It is thus advantageous to seek to limit the introduction of “harmful” saturated and/or trans lipids into products of donut type and homologs.

Thus, in the prior art, solutions have been described for eliminating the frying step in relation to donuts. The problem is that the result obtained is not equal to what is required. The texture of donuts baked in an oven is no longer at all identical to that desired. Said donuts are more like small cakes with a brioche-like texture.

Thus, the known solutions of the prior art very often result in products which have a poorer final quality, in terms of texture and taste in particular.

There is thus a real need to produce donuts and homologs which have a low calorie content and which are consequently better for the health. The solutions proposed should result in products which have the same organoleptic properties as the “traditional” products. Moreover, the solutions proposed should be able to be used by those skilled in the art without any drastic change in the recipes and preferably on a large scale, on online productions.

### SUMMARY OF THE INVENTION

Armed with this observation and after numerous research studies, the applicant company has to its credit met all the demands required and has found that such an objective can be achieved as long as a microalgal flour is used as ingredient in the formulation of a composition for a fried product, said microalgal flour being capable of partially or totally replacing fats of vegetable and/or animal origin, and more particularly saturated fats generally used in the industrial production of said fried products.

It is therefore to the credit of the applicant to have discovered that a microalgal flour can, surprisingly and unexpectedly compared with the prerequisites of the prior art, partially or totally replace fats of animal and/or vegetable origin and more particularly saturated fats generally used in the industrial production of said fried products, while at the same time retaining the organoleptic qualities, in particular gustative, olfactory, visual and tactile qualities, at least equivalent, or even superior, to those of the conventional fried products containing these ingredients.

Consequently, the present invention concerns a fried product obtained from a composition for a fried product comprising flour, yeast, microalgal flour and a drinkable liquid. According to the invention, the composition for a fried product, or initial composition, is also capable of containing a sweetening substance, and preferably saccharose, allulose and/or any mixtures thereof. According to this embodiment, said composition comprises up to 20%, preferably less than 10%, of a sweetening substance, preferably chosen from saccharose, allulose and/or any mixtures thereof, these percentages being expressed relative to the total weight of the ingredients used in the composition.

Still according to the invention, said composition may comprise up to 80%, in particular between 10% and 80%, preferentially between 20% and 70%, preferably between 30% and 65%, and even more preferentially between 35% and 55%, of flour, these percentages being expressed relative to the total weight of the ingredients used in the composition.

In a secondary embodiment, the composition does not contain gluten.

According to another embodiment of the invention, said composition for a fried product may comprise up to 30%, preferably less than 20%, more preferentially less than 10%, and even more preferentially less than 5%, of eggs or egg products, these percentages being expressed relative to the total weight of the ingredients used in the composition.

It is also capable of containing up to 30%, preferably less than 20%, more preferentially less than 10%, and even more preferentially less than 5%, of milk derivatives, these percentages being expressed relative to the total weight of the ingredients used in the composition.

By virtue of the use of a microalgal flour, the composition is also characterized in that the fats of vegetable origin and/or animal origin have been partially or totally replaced by microalgal flour, and the replacement is preferably total.

Said composition is also characterized by a fat content which is reduced by 30%, preferably by 40% and even more preferentially by 55% in comparison with the fat content contained in the usual composition for a fried product, that is to say free of microalgal flour, these percentages being expressed relative to the total weight of the ingredients used in the composition.

In the composition according to the invention, the fat normally used, of vegetable and/or animal origin, can be replaced with a mixture of microalgal flour and of a drinkable liquid, which may preferentially be water, it being possible for said water to be spring water, mineral water, water that is naturally sparkling or sparkling through the addition of carbon dioxide, or still. Thus, 100 parts of the fat normally used are advantageously replaced by 5 to 50 parts of microalgal flour and 50 to 95 parts of a drinkable liquid, and in particular 10 parts of microalgal flour and 90 parts of a drinkable liquid, 15 parts of microalgal flour and 85 parts of a drinkable liquid, 25 parts of microalgal flour and 75 parts of a drinkable liquid, 35 parts of microalgal flour and 65 parts of a drinkable liquid.

In another embodiment of the invention, the composition for a fried product is characterized in that it comprises from 0.5% to 20% of microalgal flour, preferably from 1% to 15%, more preferentially from 1% to 10%, and even more preferentially from 1% to 5%, these percentages being expressed relative to the total weight of the ingredients used in the composition.

According to one embodiment of the invention, the composition for a fried product may comprise between 5% and 75% of drinkable liquid, preferentially between 10% and 70%, more preferentially between 20% and 50%, these percentages being expressed relative to the total weight of the ingredients used in the composition. The drinkable liquid is understood to mean all of the liquids used in the composition, including, where appropriate, the liquid milk and milk derivatives and the liquid eggs or egg products.

Still according to one embodiment of the invention, the composition is also characterized in that the sum of the components consisting of the microalgal flour and the drinkable liquid represents at least 25%, and preferably at least 30%, by weight of all of the ingredients used in the composition for a fried product. In particular, the sum of the components consisting of the microalgal flour and the drinkable liquid can represent between 5% and 75%, preferentially between 10% and 60%, more preferentially between 20% and 50%, by weight of all of the ingredients used in the composition for a fried product.

According to one embodiment of the invention, the microalgal flour contained in said composition is a flour of microalgae of the Chlorella genus, and more particularly of the Chlorella protothecoides species.

In a first embodiment, the microalgal flour is in the form of non-lyzed cells.

In a second embodiment, the microalgal flour is in the form of partially lyzed cells and contains from 25% to 75% of lyzed cells.

In a final embodiment, the microalgal flour is in the form of strongly lyzed cells and contains 85% or more of lyzed cells, preferably 90% or more. Said microalgal flour used in the composition for a fried product according to the invention preferentially contains at least 12%, at least 25%, at least 40%, at least 50% or at least 75% by dry weight of lipids.

In one particular embodiment of the invention, the composition for a fried product comprises between 30% and 80% of flour, yeast, between 0.5% and 20% of eggs or egg products and between 0.5% and 20% of microalgal flour, the percentages being expressed by weight of all of the ingredients used in the composition for a fried product. It can also comprise between 0.5% and 20% of sweetening substance and/or between 0.5% and 20% of milk derivatives, the percentages being expressed by weight of all of the ingredients used in the composition for a fried product.

The invention also concerns the use of a composition as described above for preparing fried products.

Another aspect of the invention also concerns a method for preparing a fried product comprise a composition as described above, characterized in that it comprises the following steps:
a step of mixing the flour, the eggs or egg products, the yeast and the microalgal flour with a drinkable liquid, preferentially water,
a step of fermenting this mixture,
a step of shaping said mixture into dough balls,
a step of cooking said dough balls in a bath of hot oil between 150° C. and 200° C. for a period ranging from 30 seconds to 3 minutes for each side.

Said method according to the invention makes it possible to obtain fried products having a total fat content reduced by at least 30%, preferably 40% and even more preferentially 45% relative to the fried product obtained according to a standard composition.

In the context of the invention, a standard composition for a fried product is understood to mean a composition free of microalgal flour, which is conventionally composed of flour, yeast and a drinkable liquid.

A third aspect of the present invention also concerns a fried product that can be obtained by using said composition according to the invention and/or by means of the preparation method still according to the invention, characterized in that it comprises microalgal flour and the fat content of which is reduced by at least 30%, preferably 40% and even more preferentially 45%, relative to the fried product obtained according to a standard composition.

More generally, the invention relates to a fried product comprising flour, yeast, microalgal flour and a drinkable liquid. According to the invention, the fried product obtained may optionally be sweet and may preferably contain saccharose, allulose and/or any mixtures thereof.

Still according to the invention, the fried product may also be dusted with sugar, glazed, iced with melted sugar, covered with a sweet and flavored topping, and/or filled with a confectioner's custard, with savory or sweet and/or flavored Chantilly cream, with a ganache, with a fatty filling.

The invention also concerns the use of a microalgal flour as a fat replacer in the preparation of a composition for a fried product according to the invention.

The invention also relates to the use of microalgal flour for reducing the fat content in a fried product. Advantageously, the use of such a microalgal flour makes it possible to reduce the fat content by at least 30%, preferably 40% and even more preferentially 45% relative to the fried product free of microalgal flour.

The invention also provides a method for reducing the fat content in a fried product, according to which the flour of the composition for a fried product is at least partially replaced by microalgal flour.

### DETAILED DESCRIPTION OF EMBODIMENTS

Thus, the present invention concerns a composition for a fried product comprising flour, yeast, microalgal flour and a drinkable liquid.

In the present invention, the name “fried product” used should be understood in its widest interpretation and as denoting a product consisting of a mixture at least of flour, yeast and fat, and the mixture of which is then fried in small amounts of dough preferentially in a bath of hot oil between 150° C. and 250° C. for a period ranging from 2 seconds to 3 minutes each side. Said fried product can also be fried after having been sprayed with oil, placed in a dish and subjected to infrared radiation or else be fried after having been sprayed with oil, placed in a dish and subjected to baking in an oven.

In the present invention, the name “oil” used should be understood in its broadest interpretation and as denoting triglycerides, diglycerides, monoglycerides, phospholipids and/or any mixtures thereof. The oil may be solid or liquid at ambient temperature.

Thus, for the purposes of the present invention, the name “fried product” denotes particularly products of the type such as donuts, churros, round donuts, Dutch donuts, sugar-covered fritters, tempura, etc.

In one preferred embodiment of the invention, the composition for a fried product is characterized in that it also comprises a sweetening substance, and preferably saccharose, allulose and/or any mixtures thereof.

According to this embodiment, the composition according to the invention is characterized in that it comprises up to 20%, preferably less then 15%, more preferentially less than 10%, and even more preferably less than 5%, of a sweetening substance, preferably chosen from saccharose, allulose and/or any mixtures thereof, these percentages being expressed relative to the total weight of the ingredients used in the composition. For example, the composition comprises between 0.5% and 20%, preferentially between 1% and 15%, more preferentially between 1% and 10%, and even more preferably between 1% and 5%, of a sweetening substance.

Saccharose, or sucrose, is a disaccharide consisting of a glucose molecule bonded to a fructose molecule by a glycosidic bond. It is the table sugar extracted from sugarcane or from sugar beet.

Allulose or psicose is a ketohexose consisting of a chain of five carbon elements and also a ketone function, which has a strong sweetening power.

In a secondary embodiment, the composition for a fried product according to the invention may also contain another sweetening substance, chosen for example from glucose (or dextrose), glucose syrup, invert sugar, fructose or levulose, lactose, maltose, honey, maple syrup, intense sweeteners, polyols such as sorbitol or maltitol, isomalt, stevia and/or any mixtures thereof.

According to the invention, the composition for a fried product is characterized in that it comprises up to 80%, and in particular between 10% and 80%, preferentially between 20% and 70%, more preferentially between 30% and 65%, and even more preferentially between 35% and 55%, of flour, these percentages being expressed relative to the total weight of the ingredients used in the composition.

In one embodiment of the present invention, the flour used in said compositions for a fried product is in the form of a powder obtained by grinding and milling cereals. It denotes, in general, wheat flours, that is to say standard flours of the flour industry, from white flour to wholewheat flour.

In a secondary embodiment of the invention, the flour used is a flour which does not contain gluten, and which can in particular be chosen from rice flour, chestnut flour, lupin flour, chickpea flour, buckwheat flour, cornflour, quinoa flour, coconut flour, tiger nut flour, grapeseed flour, millet flour, hemp flour, and any mixtures thereof.

In another embodiment, the flour used can be obtained from raw materials generally containing gluten but having been made “gluten-free” by special treatments well known to those skilled in the art. For example, the gluten can be extracted from flours naturally containing it by washing of starch. The dough obtained is rinsed and kneaded until the rinsing water becomes clear and is free of starch. Thus, the flour may also be of all botanical origins containing gluten, provided that it undergoes a particular process for removing the gluten. Thus, flours derived from wheat (or soft wheat or spelt), from barley, from rye or from triticale (wheat+rye) can also be used, provided that they are indeed devoid of gluten (gluten free) after the extraction processes implemented.

Thus, in a secondary embodiment of the invention, the composition for a fried product does not contain gluten.

Gluten is a protein mixture combined with starch in the endosperm of most cereals. It constitutes approximately 80% of the proteins contained in wheat. Gluten is divided up into two groups: prolamins (gliadins in wheat), responsible for celiac disease and very pernicious intolerance, and glutenins.

In another embodiment of the invention, the composition for a fried product contains eggs or egg products.

According to the invention, the composition for a fried product may then comprise up to 30%, preferably less than 15%, more preferentially less than 10%, and even more preferentially less than 5%, of eggs or egg products, these percentages being expressed relative to the total weight of the ingredients used in the composition. For example, the composition comprises between 0.5% and 30%, preferentially between 1% and 15%, more preferentially between 1% and 10%, and even more preferably between 1% and 5%, of eggs or egg products.

In the present invention, the term “eggs or egg products” should be understood in its broadest interpretation and as denoting, for example, and in a nonlimiting manner, whole eggs including those which have a white or brown shell and which are of any animal origin, and equally egg substitutes, including egg derivatives, for instance and without limitation egg whites (albumen) and egg yolks, and which may be in various forms, such as concentrated, frozen, powdered, liquid, spray-dried, etc.

In one embodiment of the invention, the eggs or egg products are in spray-dried form.

In breadmaking and the bakery trade, eggs are used to improve the taste and color of products. They also soften the dough, by virtue in particular of the lecithin that they contain. They also have a hydrating role in terms of the flour and create the moisture required for fermentation of the dough. Finally, they make it possible to increase the volume of the final products.

According to the invention, the composition for a fried product may also contain milk derivatives.

According to the invention, the composition for a fried product may also comprise up to 30%, preferably less than 10%, and even more preferentially less than 5%, of milk derivatives, these percentages being expressed relative to the total weight of the ingredients used in the composition. For example, the composition comprises between 0.5% and 30%, preferentially between 1% and 15%, more preferentially between 1% and 10%, and even more preferably between 1% and 5%, of milk derivatives.

In the present invention, the term “milk or milk derivatives” should be understood in its broadest interpretation and as denoting, for example, and in a nonlimiting manner, any product obtained following any treatment of the milk, which may contain food additives and other ingredients functionally necessary for the treatment (definition in the Codex Alimentarius). These are, for example, fundamental milk ingredients, for instance skimmed or whole milk powders, caseins and caseinates, whey products, for instance sweet or acid wheys, serum proteins, or permeates.

In legal terms, only one clear definition, dating from 1909, exists defining milk of animal origin: “Milk is the integral product of the complete and uninterrupted milking of a healthy well-nourished milking female which is not overworked. It should be collected cleanly and not contain colostrum.” The word “milk” without any indication of the animal species of origin is, in terms of French legislation, reserved for cow's milk. Any milk originating from a milking female other than a cow should be denoted by the name “milk” preceded by the indication of the animal species from which it comes, for example “goat's milk”, “ewe's milk”, “ass milk”, “buffalo milk”, etc. However, for the purposes of the present invention, the milk and the milk products may originate from any animal species.

In breadmaking and the bakery trade, milk has a beneficial action on the dough and a positive effect on several phases of product production. It improves the structure and the hydration of doughs, promotes and regulates fermentation, and improves the baking of the dough and the flavor and also the coloring of the products upon baking. It also makes the crumb moist, and increases the shelf life of the final products. Milk is the second most common liquid element used by bakers.

Milk is also known to be a gustative agent. It slightly sweetens doughs and softens tastes and also makes it possible to fix flavors. It is a very good texturing agent. It makes doughs supple.

In one embodiment of the invention, the milk or milk derivatives are in spray-dried form.

Conventionally, compositions for fried products of donut type contain fat of shortening type. This is borne out in particular for all the compositions for industrial fried products.

Shortening is a vegetable fat that is partially liquid and partially solid at a temperature of 10° C., that can for example be chosen from soybean oil, sunflower oil, cottonseed oil, palm oil, coconut oil, rapeseed oil, copra oil and any derivatives and/or mixtures thereof. Shortening is thus a member of the fats described as vegetable fats.

Fats of shortening type do not have a good press because they belong to the category of saturated lipids which contribute to increasing bad cholesterol of LDL type, thus increasing the risks of cardiovascular diseases.

Occasionally, the compositions for fried products may also contain fats in other forms, such as butter, margarine or oil.

In the present invention, the term “fat” should be understood in its broadest interpretation and as denoting, for example, and in a nonlimiting manner, any product chosen from butters, margarines, oils or microalgal four and/or any mixtures thereof.

In the present invention, the term “fat of vegetable and/or animal origin” should be understood in its broadest interpretation and as denoting, for example, in a nonlimiting manner, any product chosen from butters, margarines or oils and/or any mixtures thereof.

One advantage of the present invention is the capacity of the microalgal flour to totally or partially replace the fats of vegetable and/or animal origin normally used, while at the same time preserving the organoleptic qualities of the fried product, or even improving them. In addition, this replacement can be carried out without changing, at the very least substantially, the recipes for preparing the compositions for fried products.

According to one embodiment of the invention, the composition for a fried product is characterized in that the fats of vegetable and/or animal origin have been partially or totally replaced by microalgal flour.

According to one particularly preferred embodiment, the composition for a fried product is characterized in that the fats of vegetable and/or animal origin have been totally replaced by microalgal flour. The replacement of the fats of vegetable and/or animal origin is thus total.

The term “totally” is intended to mean that the composition for a fried product according to the present invention does not comprise the replaced ingredients, preferably even in trace amounts. The term “partially” is intended to mean that, in comparison with the recipe used, the content of the ingredient replaced is reduced by at least 10%, 20%, 30%, 40%, 50%, 60%, 70%, 80% or 90% by weight, for example by approximately 10%, 20%, 30%, 40%, 50%, 60%, 70%, 80% or 90% by weight.

The term “approximately” is intended to mean the value plus or minus 10% thereof, preferably plus or minus 5% thereof. For example, “approximately 100” means between 90 and 110, preferably between 95 and 105.

As a consequence of the replacement, the compositions for a fried product according to the present invention have a calorie content lower than that of the standard fried products and are thus suitable for consumption by individuals worried about their figure, their shape and their health.

According to the invention, the composition for a fried product advantageously has a fat content which is reduced by 30%, preferably by 40% and even more preferentially by 55% in comparison with the fat content contained in the usual composition for a fried product, free of microalgal flour, these percentages being expressed relative to the total weight of the ingredients used in the composition. Thus, the total fat content in the composition according to the invention is advantageously between 0.5% and 25%, preferentially between 1% and 15%, and even more preferably between 1.5% and 10%, these percentages being expressed relative to the total weight of the ingredients used in the composition.

According to the invention, the total or partial replacement, but preferably total replacement, of the fat of origin by microalgal flour thus makes it possible to reduce the fat content of said composition, and thus to improve its calorie content.

Indeed, the replacement is not carried out weight for weight, but as a mixture with a drinkable liquid. Thus, 100 parts of fat normally used, of vegetable and/or animal origin, are replaced by a mixture comprising from 5 to 50 parts of microalgal flour and from 50 to 95 parts of a drinkable liquid, and in particular 10 parts of microalgal flour and 90 parts of a drinkable liquid, 15 parts of microalgal flour and 85 parts of a drinkable liquid, 25 parts of microalgal flour and 75 parts of a drinkable liquid, or 35 parts of microalgal flour and 65 parts of a drinkable liquid. In one particular embodiment, 100 parts of fat normally used are replaced by a mixture of 25 parts of microalgal flour and 75 parts of a drinkable liquid. As a result, the calorie content is necessarily reduced. Advantageously, the replacement mixture according to the invention comprises between 0.5% and 25%, preferentially between 1% and 15%, by weight of microalgal flour and between 20% and 70%, preferentially between 25% and 60%, and more preferentially between 30% and 50%, by weight of drinkable liquid.

It is thus entirely surprising and unexpected that 100 parts of fat normally used, of vegetable and/or animal origin, can be replaced by a mixture of microalgal flour and a drinkable liquid without having an impact on the final organoleptic qualities of said fried product. Moreover, this replacement can be carried out by those skilled in the art without any drastic change in the recipes and preferably on a large scale, on online productions. This represents the entire advantage of the invention described herein.

For the purposes of the invention, the term “drinkable liquid” should be understood in its broadest interpretation and as denoting, for example and in a nonlimiting manner, water, fruit juices, fruit nectars, vegetable juices, vegetable nectars, and sodas.

According to one preferred mode of the invention, the drinkable liquid is water, it being possible for said water to be spring water, mineral water, water that is naturally sparkling or sparkling through the addition of carbon dioxide, or still.

According to another preferred embodiment of the invention, the drinkable liquid can also totally or partly consist of eggs or egg products and/or of milk or milk derivatives, it being understood that, in this case, they are in liquid form.

Thus, the drinkable liquid may be either water; or a mixture of water and eggs or egg products in liquid form; or a mixture of water and milk or milk derivatives in liquid form; or a mixture of water, eggs or egg products in liquid form and milk or milk derivatives in liquid form; or a mixture of eggs or egg products in liquid form and milk or milk derivatives in liquid form.

According to one embodiment of the invention, the composition for a fried product may comprise between 5% and 75% of drinkable liquid, preferentially between 10% and 70%, more preferentially between 20% and 50%, these percentages being expressed relative to the total weight of the ingredients used in the composition.

The present invention thus concerns a composition for a fried product containing microalgal flour and a drinkable liquid partially, but preferably totally, replacing the fats of vegetable and/or animal origin normally used.

It should be noted, in the present invention, that the microalgal flour replaces a part, but preferably all, of the fats of origin present in the composition for a fried product. This makes it possible to reduce the calorie content of the composition for a fried product, but also to modify the lipid profile thereof by reducing in particular the provision of bad fats.

According to the invention, the microalgal flour represents at least 0.5%, this percentage being expressed relative to the total weight of the ingredients used in the composition for a fried product.

According to the invention, the composition for a fried product comprises from 0.5% to 20% of microalgal flour, preferentially from 1% to 15%, more preferentially from 1% to 10%, and even more preferably from 1% to 5%, these percentages being expressed relative to the total weight of the ingredients used in the composition.

In one preferred embodiment, the sum of the components consisting of the microalgal flour and the drinkable liquid represents at least 20%, 25%, 30%, 35%, 40%, 50%, these percentages being expressed relative to the total weight of the ingredients used in the composition.

In particular, the sum of the components consisting of the microalgal flour and the drinkable liquid represents at least 20%, preferentially at least 25%, more preferentially at least 30%, by weight of all of the ingredients used in the composition for a fried product.

The microalgal flour according to the invention is perfectly capable of replacing the fats conventionally used and very clearly improves the nutritional profile of the fried products which contain it.

The applicant has found, surprisingly and unexpectedly, that using microalgal flour rich in lipids and/or in fibers in the composition for a fried product makes it possible to reduce the calorie content of said composition by reducing the amount of fat used.

Thus, said microalgal flour rich in lipids and/or in fibers has, firstly, a fat replacer property, while allowing the fried product to retain the desired sensory characteristics both in terms of texture (melt-in-the-mouth, moistness) and in terms of taste, since it has a high water-retaining capacity which makes it possible to put more water in the composition for a fried product. What is more, the water additionally added to the composition for a fried product according to the invention has the particularity of remaining within the composition and thus within the fried product resulting therefrom, without affecting the water activity thereof and the stability of the final fried product.

Having compositions for a fried product that are more hydrated significantly improves the moistness with regard to the final fried product. Not only is the fat reduced, but the organoleptic qualities are improved. There are thus multiple advantages of the invention.

Furthermore, the moist nature is retained over time. Thus, the shelf life, also called UBD or Use-By Date, is increased. This again provides a definite advantage for the numerous patisserie manufacturers which are constantly seeking extended shelf lives without having recourse to additives that consumers refuse to have anything to do with.

Algae are among the first organisms which appeared on Earth, and are defined as eukaryotic organisms devoid of roots, stem and leaf, but having chlorophyll and also other pigments secondary to oxygen-producing photosynthesis. They are blue, red, yellow, golden and brown or else green. They represent more than 90% of marine plants and 18% of the plant kingdom, with their 40 000 to 45 000 species. Algae are organisms that are extremely varied both in terms of their size and their shape and in terms of their cell structure. They live in an aquatic or very humid medium. They contain numerous vitamins and trace elements, and are true concentrates of active agents that stimulate and are beneficial to health and beauty. They have anti-inflammatory, moisturizing, softening, regenerating, firming and anti-aging properties. They also have “technological” characteristics which make it possible to give a food product texture. Indeed, the famous additives E400 to E407 are in fact only compounds extracted from algae, the thickening, gelling, emulsifying and stabilizing properties of which are used.

Among the algae, macroalgae and microalgae can be distinguished, in particular single-celled microscopic algae, which are photosynthetic or non-photosynthetic, and of marine or non-marine origin, cultured in particular for their applications as biofuel or in the food sector. For example, spirulina (Arthrospira platensis) is cultured in open lagoons (under phototrophic conditions) for use as a food supplement or incorporated in small amounts into confectionery products or drinks (generally less than 0.5% w/w). Other lipid-rich microalgae, including certain species of Chlorella, are also very popular in Asian countries as food supplements (mention may be made of microalgae of the Crypthecodinium or Schizochytrium genus). The production and use of microalgal flours is described in applications WO 2010/120923 and WO 2010/045368.

For the purposes of the present invention, the term “microalgal flour” should be understood in its broadest interpretation and as denoting, for example, a composition comprising a plurality of particles of microalgal biomass. The microalgal biomass is derived from microalgal cells, which may be whole or broken, or a mixture of whole and broken cells. It is understood in the present document that the microalgal flour denotes a product essentially composed of microalgal biomass, i.e. at least 90%, 95% or 99%. In one preferred embodiment, the microalgal flour comprises only microalgal biomass.

The present invention thus relates to the microalgal biomass suitable for human consumption which is rich in nutrients, in particular in lipids and/or proteins.

The invention also relates to a microalgal flour which can be incorporated into food products in which the lipid and/or protein content of the microalgal flour can totally or partially replace the oils and/or fats and/or proteins present in conventional food products.

The lipid fraction of the microalgal flour, which may be composed essentially of monounsaturated oils, thus provides nutritional and health advantages compared with the saturated, hydrogenated and polyunsaturated oils often found in conventional food products.

The protein fraction of the microalgal flour which contains many amino acids essential to human and animal well being therefore also provides advantageous and not insignificant nutritional and health advantages.

For the purposes of the invention, the microalgae under consideration are species which produce appropriate oils and/or lipids and/or proteins.

According to the invention, the microalgal biomass comprises at least 10% by dry weight of lipids, preferably at least 12% and even more preferentially from 25% to 35% or more by dry weight of lipids.

Thus, according to the present invention, the expression “rich in lipids” should be interpreted as referring to contents of at least 10% by dry weight of lipids, preferably of at least 12% by dry weight of lipids and even more preferentially contents of at least 25% to 35% or more by dry weight of lipids.

According to one preferential mode of the invention, the microalgal biomass contains at least 12%, at least 25%, at least 35%, at least 40%, at least 50% or at least 75% by dry weight of lipids. For example, the microalgal biomass comprises between 45% and 55% by dry weight of lipids.

According to one particularly preferred mode, the microalgal biomass contains at least 40% of lipids, and preferably at least 50% of lipids by dry weight.

According to another embodiment of the invention, the microalgal biomass contains at least 10% by dry weight of proteins, at least 20%, at least 30%, at least 40% or at least 45% by dry weight of proteins.

According one particular embodiment, the microalgal biomass contains at least 35% by dry weight of lipids and at most 20% by dry weight of proteins.

Thus, depending on the recipe of the product, the baker/pastry maker will instead be able to choose to incorporate into his recipe for a composition for fried products a microalgal flour having a high content of lipids or instead a microalgal flour having a high protein content, a microalgal flour having both a high lipid and a high protein content, or else a mixture of the two types of microalgal flours.

According to one preferred mode, those skilled in the art will choose a microalgal flour having a high lipid content, of at least 40% and preferably at least 50% by dry weight.

According to another preferential mode of the invention, the microalgae belong to the Chlorella genus.

Chlorella is a freshwater microscopic green single-celled alga or microalga which appeared on Earth more than 3 billion years ago, belonging to the Chlorophyte branch. Chlorella possesses the greatest concentration of chlorophyll of all plants, and it has a considerable photosynthesis capacity. Since its discovery, Chlorella has not ceased to generate considerable interest throughout the world, and today it is produced on a large scale for uses in food and nutritional supplements. Indeed, Chlorella contains more than 60% of proteins which contain many amino acids essential to human and animal well being. Chlorella also contains many vitamins (A: beta-carotene, B1: thiamine, B2: riboflavin, B3: niacin, B5: pantothenic acid, B6: pyridoxine, B9: folic acid, B12: cobalamin, vitamin C: ascorbic acid, vitamin E: tocopherol, vitamin K: phylloquinone), lutein (carotenoid family, powerful antioxidant) and minerals, including calcium, iron, phosphorus, manganese, potassium, copper and zinc. In addition, Chlorella contains certain omega-type polyunsaturated fatty acids essential to good cardiac and brain function and to the prevention of numerous diseases such as cancer, diabetes or obesity.

There are a large number of benefits related to the consumption of Chlorella. It is a food supplement used daily in Japan by 4 million people. It is used to such an extent that the Japanese government has classified it as a “food of national interest”.

Optionally, the microalgae used may be chosen, non-exhaustively, from Chlorella protothecoides, Chlorella kessleri, Chlorella minutissima, Chlorella sp., Chlorella sorokiniama, Chlorella luteoviridis, Chlorella vulgaris, Chlorella reisiglii, Chlorella ellipsoidea, Chlorella saccarophila, Parachlorella kessleri, Parachlorella beijerinkii, Prototheca stagnora and Prototheca moriformis. Preferably, the microalgae used according to the invention belong to the Chlorella protothecoides species.

In the context of the invention, Chlorella protothecoides is chosen because of its high lipid composition.

In a secondary embodiment, Chlorella protothecoides is also chosen because of its high protein composition.

In the microalgal flour, the cell walls of the microalgae and/or the cell debris of the latter may optionally encapsulate the lipids at least until the food product containing the flour is baked, thereby increasing the lifetime of the lipids.

The microalgal flour also provides other benefits, such as micronutrients, dietary fibers (soluble and insoluble carbohydrates), phospholipids, glycoproteins, phytosterols, tocopherols, tocotrienols and selenium.

According to one embodiment of the invention, the composition for a fried product comprises a microalgal flour of which the total fiber content is at least 15%, and preferably at least 18% by dry weight of its composition.

According to one embodiment of the invention, the microalgae can be modified so as to reduce pigment production, or even totally inhibit it. For example, Chlorella protothecoides can be modified by UV-mutagenesis and/or chemical mutagenesis so as to have a reduced pigment content or to be devoid of pigments.

It may in fact be particularly advantageous to have microalgae free of pigment so as to avoid obtaining a more or less marked green color in the baked products in which the microalgal flour is used.

Since the microalgae are intended for the production of flours intended for food formulations, according to one preferred embodiment of the invention, the microalgae do not undergo any genetic modification, for instance mutagenesis, transgenesis, genetic engineering and/or chemical engineering. Thus, the microalgae have not undergone modifications of their genome by any molecular biology technique whatsoever.

According to this preferred mode, the algae intended for the production of the microalgal flour have the GRAS status. The GRAS (Generally Recognized As Safe) concept, created in 1958 by the Food and Drug Administration (FDA), allows the regulation of substances or extracts which are added to foods and which are considered to be harmless by a panel of experts.

The appropriate culture conditions to be used are in particular described in the article by Ikuro Shihira-lshikawa and Eiji Hase, “Nutritional Control of Cell Pigmentation in Chlorella protothecoides with special reference to the degeneration of chloroplast induced by glucose”, Plant and Cell Physiology, 5, 1964.

This article describes in particular that all the color grades can be produced by Chlorella protothecoides (colorless, yellow, yellowish green, and green) by varying the nitrogen and carbon sources and ratios. In particular, “washed-out” and “colorless” cells are obtained using culture media which are glucose-rich and nitrogen-poor. The distinction between colorless cells and yellow cells is made in this article. Furthermore, the washed-out cells cultured in excess glucose and limited nitrogen have a high growth rate. Furthermore, these cells contain high amounts of lipids.

Other articles, such as the one by Han Xu, Xiaoling Miao, Qingyu Wu, “High quality biodiesel production from a microalga Chlorella protothecoides by heterotrophic growth in fermenters”, Journal of Biotechnology, 126, (2006), 499-507, indicate that heterotrophic culture conditions, i.e. culture in the absence of light, make it possible to obtain an increased biomass with a high content of lipids in the microalgal cells.

The solid and liquid growth media are generally available in the literature, and the recommendations for preparing the particular media which are suitable for a large variety of microorganism strains can be found, for example, online at www.utex.org/, a website maintained by the University of Texas at Austin for its algae culture collection (UTEX).

In the light of their general knowledge and the abovementioned prior art, those skilled in the art responsible for culturing the microalgal cells will be entirely capable of adjusting the culture conditions in order to obtain a large biomass, rich in proteins and/or in lipids and either totally free of or with a reduced content of chlorophyll pigments.

According to the present invention, the microalgae are cultured in liquid medium in order to produce the biomass as such.

According to the present invention, the microalgae are cultured in a medium containing a carbon source and a nitrogen source, either in the presence of light, or in the absence of light.

According to one preferred mode of the invention, the microalgae are cultured in a medium containing a carbon source and a nitrogen source in the absence of light (heterotrophic conditions).

The production of biomass is carried out in fermenters (or bioreactors). The specific examples of bioreactors, the culture conditions, and the heterotrophic growth and the methods of propagation can be combined in any appropriate manner in order to improve the efficiency of the microbial growth and the lipids and/or of protein production.

In order to prepare the biomass for use in food compositions, the biomass obtained at the end of fermentation is concentrated or harvested from the fermentation medium. At the time of the harvesting of the microalgal biomass from the fermentation medium, the biomass comprises intact cells which are mostly in suspension in an aqueous culture medium.

In order to concentrate the biomass, a solid-liquid separation step is then carried out by filtration, by centrifugation or by any means known, moreover, to those skilled in the art.

After concentration, the microalgal biomass can be treated in order to produce vacuum-packed cakes, algal flakes, algal homogenates, algal powder, algal flour or algal oil.

The microalgal biomass is also dried in order to facilitate the subsequent treatment or for use of the biomass in its various applications, in particular food applications.

Various textures and flavors can be conferred on food products, depending on whether the algal biomass is dried, and if it is, depending on the drying method used. Reference may be made to patents U.S. Pat. No. 6,607,900 and U.S. Pat. No. 6,372,460 for example.

According to the present invention, the microalgal flour can be prepared from the concentrated microalgal biomass which has been mechanically lyzed and homogenized, the homogenate then being spray-dried or flash-dried.

According to one embodiment of the invention, the cells used for the production of microalgal flour are lyzed in order to release their oil or lipids. The cell walls and the intracellular components are milled or reduced, for example using a homogenizer, to non-agglomerated cell particles or debris. According to one preferential mode of the invention, the resulting particles have an average size of less than 500 μm, 100 μm or even 10 μm or less.

According to another embodiment of the invention, the lyzed cells can also be dried.

For example, a pressure disruptor can be used to pump a suspension containing the cells through a restricted orifice so as to lyze the cells. A high pressure (up to 1500 bar) is applied, followed by an instantaneous expansion through a nozzle. The cells can be broken by three different mechanisms: running into the valve, high shear of the liquid in the orifice, and a sudden drop in pressure at the outlet, causing the cell to explode.

The method releases the intracellular molecules.

A Niro homogenizer (GEA Niro Soavi) (or any other high-pressure homogenizer) can be used to break cells.

This treatment of the algal biomass under high pressure (approximately 1500 bar) generally lyzes more than 90% of the cells and reduces the size of the particles to less than 5 microns.

According to one embodiment of the invention, the pressure applied is from 900 bar to 1200 bar. Preferentially, the pressure applied is 1100 bar.

According to another embodiment, and in order to increase the percentage of lyzed cells, the microalgal biomass may undergo a high-pressure double treatment, or even more (triple treatment, etc.).

According to one preferred mode, a double homogenization is used in order to increase the percentage of lyzed cells and to obtain a level greater than 50%, greater than 75% or greater than 90%. A percentage of lyzed cells which can range up to approximately 95% has been observed by means of this double treatment. Thus, in one exemplary embodiment, the microalgal flour in the composition according to the invention comprises between 50% and 95%, preferentially between 60% and 95%, even more preferentially between 75% and 90%, by weight of lyzed cells

Lysis of the microalgal cells is optional but preferred when a flour rich in lipids (e.g. greater than 10%) is desired.

According to a first embodiment of the invention, partial lysis is desired, that is to say the microalgal flour is in the form of partially lyzed cells and contains from 25% to 75%, from 30% to 70%, from 35% to 65%, from 40% to 60%, or from 45% to 55% of lyzed cells.

According to a second, particularly preferred embodiment of the invention, maximum or even total lysis is desired, that is to say the microalgal flour is in the form of strongly or even totally lyzed cells and contains 85% or more of lyzed cells, in particular 86%, 87%, 88%, 89%, 90%, 91%, 92%, 93%, 94%, 95%, 96%, 97%, 98% or 99% and preferably more than 90%.

Thus, according to this preferred mode of the invention, the composition for a fried product comprises a microalgal flour of which the cells have been totally lyzed by means of one of the abovementioned treatments perfectly known to those skilled in the art.

Thus, in the present invention, the microalgal flour is capable of being in a non-milled form up to an extremely milled form with degrees of milling greater than 95%. Specific examples relate to microalgal flours having degrees of milling of 50%, 75%, 85% or 95% of cell lysis, preferably 85%, 86%, 87%, 88%, 89%, 90%, 91%, 92%, 93%, 94% or 95%.

In another embodiment of the invention, a protein-rich microalgal flour is produced. This protein-rich microalgal flour may be in the form of non-lyzed cells (non-lyzed and non-milled intact cells).

Alternatively, a bead mill is instead used. In this type of mill, the cells are agitated in suspension with small abrasive particles. The breaking of the cells is caused by the shear forces, the milling between the beads, and the collisions with beads. In fact, these beads break the cells so as to release the cell content therefrom. The description of an appropriate bead mill is, for example, given in the patent U.S. Pat. No. 5,330,913.

A suspension of particles, optionally of smaller size than the cells of origin, is obtained in the form of an “oil-in-water” emulsion. This emulsion can then be spray-dried and the water is eliminated, leaving a dry powder containing the cell debris and the lipids. After drying, the water content or the moisture content of the powder is generally less than 10%, preferentially less than 5% and more preferably less than 3% by weight.

However, the production of a dry powder which is tacky and flows with difficulty, since the powder obtained contains oil in a content of 10%, 25% or even 50% by weight of the dry powder, is lamentable. Various flow agents (including silica-derived products) can then be added. Problems of water-dispersibility of the dried biomass flours, which then have poorer wettability properties, may also be encountered.

The applicant company has developed microalgal flour granules which have a particular particle size distribution, and notable flow and wettability properties. In particular, these granules make it possible to stabilize the microalgal flour and to allow their easy, large-scale incorporation into food products which must remain delicious and nutritious. The method for preparing said granules is perfectly described in the two patent applications EP 2 724 625 and EP 2 777 400 of which the applicant is also the proprietor and which are incorporated into the present application by way of reference.

As described in the abovementioned two patent applications and according to one embodiment of the invention, the microalgal flour used in the composition for a fried product is in the form of microalgal flour granules having one of the following characteristics, preferably all three:
a monomodal particle size distribution, measured on a Coulter® LS laser particle size analyzer, of between 2 and 400 μm, centered on a particle diameter (D mode) between 5 and 15 μm,
flow grades, determined according to a test A, between 0.5% and 60% by weight for the oversize at 2000 μm, between 0.5% and 60% by weight for the oversize at 1400 μm and between 0.5% and 95% by weight for the oversize at 800 μm,
a degree of wettability, expressed according to a test B, by the height of the product decanted in a beaker, at a value of between 0 and 4 cm, preferably between 0 and 2 cm, and more preferentially between 0 and 0.5 cm.

The test A consists in measuring the degree of cohesion of the microalgal flour granules. The test A developed by the applicant company is more specifically described in prior application EP 2 724 625 and more particularly in paragraphs [0066]-[0070] of the publication, which are integrated by way of reference.

The test B consists in measuring the degree of wettability of the microalgal flour granules. The test B developed by the applicant company is more particularly described in prior application EP 2 724 625 and more particularly in paragraphs [0086]-[0089] of the publication, which are integrated by way of reference.

Thus, the present invention also concerns a composition for a fried product comprising flour, yeast, microalgal flour in the form of granules and a drinkable liquid.

According to the invention, the composition for a fried product also comprises yeast. The latter is required in order to cause the dough to swell and to give it a flexible and light structure with an aerated texture on the final fried product.

According to the invention, the yeast may be either chemical yeast or baker's yeast consisting of microorganisms, or a mixture of the two.

According to the invention, the composition for fried products is characterized in that it comprises up to 2%, preferably less than 1% of chemical yeast, these percentages being expressed relative to the total weight of the ingredients used in the composition. According to the invention, the composition for a fried product comprises between 0.1% and 1%, preferentially between 0.2% and 0.8%, more preferentially between 0.3% and 0.7%, and even more preferentially between 0.4% and 0.6%, of chemical yeast, these percentages being expressed relative to the total weight of the ingredients used in the composition.

According to another embodiment of the invention, the composition for fried products is characterized in that it comprises up to 10%, preferably less than 7%, and even more preferentially less than 5%, of baker's yeast, these percentages being expressed relative to the total weight of the ingredients used in the composition.

According to the invention, the composition for a fried product comprises between 1% and 10%, in particular between 1% and 7%, between 1% and 4%, and preferably between 2% and 3.7%, of baker's yeast, these percentages being expressed relative to the total weight of the ingredients used in the composition.

According to the invention, the chemical yeast (or raising powder) is a mixture composed essentially of a basic agent (such as sodium bicarbonate), an acidic agent (tartaric acid, sodium pyrophosphate) and a stabilizer (such as starch), in the form of white powder and serving to swell the doughs. Contrary to baker's yeast, which acts by fermenting live microorganisms, chemical yeast only casues chemical reactions of acid-base type. As long as the powder remains dry, the reaction does not start. When it is made wet, the acid reacts with the sodium bicarbonate and carbon dioxide is given off, said carbon dioxide swelling the dough. It is then necessary to bake it without delay.

Baker's yeast (Saccharomyces cerevisiae) is a yeast, that is to say a fungus that is single-cell and microscopic. Unlike chemical yeast, baker's yeast is a living product. Its cells have the property of converting the sugars naturally present in the flour into alcohol and carbon dioxide. In the absence of dioxygen, glucose is degraded to ethanol (alcohol) and carbon dioxide by the yeast according to the alcoholic fermentation reaction. The gas thus produced during baking causes the dough to swell. The ethanol formed evaporates off during baking.

According to the invention, the baker's yeast can be chosen from pressed yeast, crumbled yeast, liquid yeast, active dry yeast to be rehydrated beforehand, deep-frozen dry yeast with an intermediate moisture content, and any mixtures thereof.

According to the invention, the composition for a fried product may be flavored through the addition of at least one flavoring (i.e. one or more flavorings).

In the present invention, the term “flavoring” denotes all substances not intended to be consumed as they are, which are added to foodstuffs to give them an odor and/or a taste or to modify said odor and/or taste. They are derived from or consist of the following categories: flavoring substances, flavoring preparations, flavorings obtained by thermal treatment, smoke flavorings, flavoring precursors or other flavorings or mixtures thereof.

The flavoring substances are defined chemical substances, which includes flavoring substances obtained by chemical synthesis or isolated by chemical processes, and natural flavoring substances. The flavoring preparations are flavorings, other than defined chemical substances, which are obtained by means of appropriate physical, enzymatic or microbiological processes, from materials of vegetable, animal or microbiological origin taken as they are or after transformation thereof for human consumption. The flavoring precursors, such as carbohydrates, oligopeptides and amino acids, give foodstuffs a flavor via chemical reactions which occur during the transformation of these foodstuffs.

According to one preferential mode, the flavoring used can be chosen from vanilla flavoring, cinnamon flavoring, chocolate flavoring, fruit flavoring and dried fruit flavoring, such as in particular hazelnut flavoring, almond flavoring, peanut flavoring, cashew nut flavoring, pecan nut flavoring, pistachio nut flavoring, etc.

According to another secondary embodiment, the flavoring used can be chosen from savory flavorings such as ham, smoked ham, foie gras, mushrooms, pizza, bacon, etc.

According to one embodiment of the invention, the composition for a fried product comprises between 0.5% and 5%, preferentially between 0.6% and 4%, more preferentially between 0.8% and 3%, and even more preferentially between 1% and 2.5%, of flavorings, these percentages being expressed relative to the total weight of the ingredients used in the composition.

According to another embodiment, the composition for a fried product according to the invention may also contain improvers which make it possible to reinforce the moist aspect of the dough.

A subject of the invention is thus also a composition for a fried product comprising
between 0.5% and 20% of microalgal flour, preferentially between 1% and 5%,
between 5% and 75% of a drinkable liquid, and in particular water,
between 10% and 80% of flour, and
between 0.1% and 1% of chemical yeast or between 1% and 10% of baker's yeast,

these percentages being expressed relative to the total weight of the ingredients of the composition. The composition may also comprise between 0.5% and 30% of eggs or egg products, and/or between 0.5% and 5% of flavorings and/or between 0.5% and 20% of sweetening substance and/or between 0.5% and 30% of milk derivatives.

In one particular example, the composition for a fried product comprises
approximately 1.5% by weight of microalgal flour,
approximately 32% of a drinkable liquid, and in particular water,
approximately 52% of flour,
approximately 3.5% of eggs or egg products,
approximately 0.5% of chemical yeast,
approximately 6.5% of sweetening substance,
approximately 2% of milk derivative,
approximately 2% of flavoring.

In another particular example, the composition for a fried product comprises
approximately 4% by weight of microalgal flour,
approximately 38% of a drinkable liquid, and in particular water,
approximately 50% of flour,
approximately 5% of eggs or egg products,
approximately 2% of baker's yeast,
approximately 1% of flavoring.

In one preferential mode, the invention is intended for food products of the fields of cookie-making, patisserie and Viennese pastry-making.

In the present invention, the terms “bakery trade”, “patisseries” and “fried products” should be interpreted broadly, as referring generally to the field of the production of fried products from compositions of starch-based fermented doughs, and also to the fields of the bakery trade and of Viennese pastry-making.

Another aspect of the invention also concerns a method for preparing a fried product comprising a composition according to the invention.

According to the invention, the method for preparing a fried product comprises mixing flour, eggs or egg products, yeast and microalgal flour with a drinkable liquid, before cooking.

In one particular implementation, the method comprises the following steps:
a step of mixing the flour, the eggs or egg products, the yeast and the microalgal flour with a drinkable liquid,
a step of fermenting this mixture,
a step of shaping said mixture into a dough ball or dough balls,
a step of cooking said dough balls) in a bath of hot oil between 150° C. and 200° C. for a period ranging from 30 seconds to 3 minutes for each side.

In one preferential embodiment of the method according to the invention, the drinkable liquid is water.

The cooking of the composition for a fried product according to the invention in a bath of hot oil is a critical step since the fried product absorbs a not insignificant amount of frying oil, thereby considerably increasing, firstly, its calorie content, but also its content of trans lipids, which, as explained above, are harmful to the health since they increase the risk of cardiovascular diseases.

However, this frying step remains unavoidable since it makes it possible to give the final product its particular crunchy texture on the outside and soft texture on the inside.

The applicant has found, surprisingly and unexpectedly, that using microalgal flour rich in lipids and in fibers in the composition for a fried product makes it possible, firstly, to reduce the calorie content of said composition by reducing the amount of fat used, but also makes it possible to reduce the amount of oil absorbed by the fried product during cooking thereof in the bath of oil.

Thus, surprisingly and unexpectedly, the applicant, in seeking to reduce the fat content in compositions for a fried product by replacing therein the fat conventionally used with a microalgal flour, and preferably a microalgal flour rich in lipids and/or in fibers, has also noted that the compositions for a fried product according to the invention exhibit less fat uptake linked to the cooking thereof in a bath of oil than the conventional compositions for a fried product.

The present invention thus also concerns a method of preparation for a fried product comprising the steps previously described and making it possible to obtain fried products having a total fat content reduced by at least 30%, preferably by at least 40% and even more preferentially by at least 45% relative to the fried product obtained according to a standard composition.

According to one particularly advantageous mode, the present invention thus also concerns a method of preparation for a fried product comprising the steps previously described and making it possible to obtain fried products having a total fat content reduced by at least 50% relative to the fried product obtained according to a standard composition.

In the present invention, the total fat content, measured on the fried products, includes both the fats used in the composition for a fried product, but also those introduced by the frying in a bath of hot oil and/or according to the other means previously described.

There are thus multiple advantages of the invention.

A final aspect of the invention also concerns a fried product containing microalgal flour and the fat content of which is reduced by at least 30%, preferably 40% and even more preferentially by 45% relative to the fried product obtained according to a standard composition, free of microalgal flour.

According to this final aspect, the present invention also concerns a fried product concerning microalgal flour and the fat content of which is reduced by at least 50% relative to the fried product obtained according to a standard composition.

Said fried product according to the invention is obtained by using a composition for a fried product according to the invention and/or by using the method for preparing the fried product also according to the invention.

Because of the significant reduction in the final content of total fats, the fried product according to the invention has a nutritional profile that is much more advantageous and healthy than the nutritional profile of a fried product prepared according to a standard recipe, free of microalgal flour.

As previously specified, in the present invention, the name “fried product” used should be understood in its widest interpretation and as denoting a product consisting of a mixture at least of flour, yeast and fat, and the mixture of which is then fried in small amounts of dough preferentially in a bath of hot oil between 150° C. and 250° C. for a period ranging from 2 seconds to 3 minutes each side. Said fried product can also be fried after having been sprayed with oil, placed in a dish and subjected to infrared radiation or else be fried after having been sprayed with oil, placed in a dish and subjected to baking in an oven.

Thus, the name “fried product” denotes particularly products of the type such as donuts, churros, round donuts, Dutch donuts, sugar-covered fritters, tempura, etc.

According to one preferential embodiment, the fried products according to the invention may be sweet or savory. They can be plain or else can be filled with jelly, chocolate, confectioner's custard, Chantilly cream, foie gras, savory mousses, etc.

According to one preferred mode of the invention, the fried products are sweet and preferably contain saccharose, allulose and/or any mixtures thereof.

According to another embodiment of the invention, they can also be dusted with sugar, glazed, iced with melted sugar, covered with a sweet and flavored topping, etc.

According to another embodiment of the invention, the fried products can also be filled with a confectioner's custard, with savory or sweet and/or flavored Chantilly cream, with a ganache or with a fatty filling.

Ganache is a thick preparation of chocolate used to garnish a confectionery product or a patisserie product. In its simplest form, ganache is a mixture of cream (or sometimes milk or butter, or even a mixture of all three) and of chocolate, generally in approximately equal amounts.

Fatty fillings with milk are all mixtures obtained from sugar and vegetable and/or animal fats, which conventionally contain milk proteins and which are intended to be used as filling garnish in confectionery product production, patisserie production, the bakery trade, the cookie trade and any other area of food production. Such examples are for example praline-flavored fatty fillings and imitation “chocolate” fatty fillings.

The invention also relates to the use of a microalgal flour as a fat replacer in the preparation of a composition for a fried product.

The invention will be understood more clearly on reading the examples which follow, which are intended to be illustrative while referring only to certain embodiments and certain advantageous properties according to the invention, and nonlimiting.

### EXAMPLES

### Example 1

### Production of the Microalgal Flour

A strain of Chlorella protothecoides, reference UTEX 250, is cultured in a fermenter and according to techniques known to those skilled in the art, in such a way that it does not produce chlorophyll pigment. The resulting biomass is then concentrated so as to obtain a final concentration of microalgal cells of 150 g/l.

The cells are optionally deactivated by heat treatment through an HTST (High Temperature/Short Time) zone at 85° C. for 1 minute.

For the rest of the operations, the temperature can be maintained under 8-10° C.

The washed biomass is then milled using a ball mill which may be of bead mill type, and several degrees of milling, in particular of lysis, are then sought: 50% milling and 85% milling.

In one of the embodiments, no milling is applied and the degree of milling is thus zero.

The biomass thus generated and optionally milled can then be pasteurized on an HTST zone (1 minute at 70-80° C.) and homogenized under pressure in a two-stage Gauvin homogenizer (250 bar at the 1st stage/50 bar at the second) after adjustment of the pH to 7 with potassium hydroxide.

Three batches of microalgal flour are thus obtained:
0% batch: no milling is applied;
50% batch: the degree of cell lysis after milling is 50%.
85% batch: the degree of cell lysis after milling is 85%.

According to the culture conditions applied, the lipid content of the microalgal biomass is greater than 35%, and the protein content less than 20%.

The batch exhibiting a degree of milling of 85% has a lipid content of the microalgal biomass of between 45% and 55%.

### Example 2

### Drying of the Homogenized “Oil-in-Water” Emulsion of Microalgal Flour

The three batches of biomass obtained in example 1 are dried in a Filtermat device, so as to obtain the microalgal flour granules.

The spray-drying process consists in spraying the homogenized suspension at high pressure in a device of Filtermat type sold by the company GEA/Niro, fitted with a high-pressure injection nozzle of Delavan type, under the following conditions:
the pressure is regulated from 160 to 170 bar,
spray-drying input temperature: 180° C. to 200° C.,
output temperature: 60° C. to 80° C.,
drying zone input temperature: 60° C. to 90° C.,
output temperature: 65° C.,
cooling zone input temperature: 10° C. to 20° C.

The powder then reaches the belt with a residual moisture content of between 2% and 4%.

At the belt output: the microalgal flour granules have a residual moisture content of between 1% and 3%, about 2%.

### Example 3

### Compositions for Fried Products and Fried Products of Donut Type Which are Low Fat According to the Invention

Low-fat donuts were prepared according to the invention from compositions for a fried product containing microalgal flour.

The tests were reproduced twice in order to demonstrate the reproducibility.

The batch milled at 85%, of example 1, was used in said recipes.

The fat replacement is as described above in the description: 100 parts of fat normally used, of vegetable and/or animal origin, are replaced by a mixture of 25 parts of microalgal flour and 75 parts of water.

The recipes are given in table 1 below.

There were no modifications in the recipe in terms of the preparation method.

3.1. Compositions:

TABLE 1

| | |
|---|---|
| CONTROL | TEST |

| | g | % | g | % |
|---|---|---|---|---|
| Wheat flour | 1000.0 | 48.8 | 1000.0 | 48.8 |
| Gluten | 50 | 2.4 | 50 | 2.4 |
| Saccharose (sucrose) | 125.0 | 6.1 | 125 | 6.1 |
| Microalgal flour | — | — | 25 | 1.2 |
| Whole egg powder | 50.0 | 2.4 | 50.0 | 2.4 |
| Skimmed milk powder | 30.0 | 1.5 | 30.0 | 1.5 |
| Chemical yeast (raising | 7.5 | 0.4 | 7.5 | 0.4 |
| powder) Volcano | | | | |
| Ascorbic acid | 0.2 | 0.0 | 0.2 | 0.0 |
| Salt | 10.0 | 0.5 | 10 | 0.5 |
| Bread improvers | 7.7 | 0.4 | 7.7 | 0.4 |
| Vanilla flavoring | 20.0 | 1 | 20.0 | 1 |
| Pressed fresh yeast | 70.0 | 3.4 | 70.0 | 3.4 |
| Fats Biscuitine 500 | 100 | 4.9 | — | — |
| Water at 32° C. | 580.0 | 28.3 | 655.00 | 31.9 |
| | 2050.4 | 100 | 2050.4 | 100 |

The Volcano chemical yeast is sold by the company Puratos, Industrialaan 25, 1702 Groot-Bijgaarden, Belgium.

The improver used is of Nutrisoft 55 type: emulsifyer of monoglyceride type. This improver is sold by the company BASF Chemtrade GmbH, Burg bernheim, Germany.

The fat of Biscuitine 500 type is a mixture of fractionated and non-hydrogenated vegetable fats which is sold by the company Loders Croklaan BV, also known as “shortening”.

3.2. Protocol for Preparing the Compositions for a Fried Product According to the Invention
Introduction of the various ingredients into the kneading machine.
Kneading for 2 minutes at speed 1, then for 8 minutes at speed 2.
Bulk fermentation for 10 minutes.
Cutting up, weighing dough pieces of 40 g) and shaping into balls.
Proving or proofing in an oven at 49° C., 80% RH for 30 minutes.

3.3. Protocol for Preparing the Fried Products According to the Invention
Cooking the dough pieces previously obtained by frying in an oil at 180° C. for approximately 1 min 30 sec on each side.

The donut is turned over when the surface is nicely golden.

3.4. Indicative Nutritional Values of the Compositions for a Fried Product Before Cooking by Frying

All the values are given in weight per 100 g of composition for a fried product. They are calculated theoretically as a function of the amount of each ingredient used and of its standard nutritional value.

TABLE 2

| | Control | TEST |
|---|---|---|
| Calories (kCal/kJ) | 279 kCal/1166 kJ | 243 kCal/1015 kJ |
| Proteins | 10 | 10.1 |
| Fats | 7.0 | 2.7 |
| Carbohydrates | 44.1 | 44.3 |
| . . . among which DP1,2 | 7.1 | 7.1 |
| Fibers | 1.3 | 1.5 |
| . . . insoluble fibers | 1.2 | 1.3 |
| . . . soluble fiber | 0.0 | 0.2 |

| | |
|---|---|
| Fat reduction | 61% |
| Calorie reduction | 12.9% |

Thus, the recipe of the composition for fried products comprising microalgal flour enables a 61% reduction in the fat in the composition before frying, which is very significantly less than the fat content of the control composition.

The advantage of the invention with regard to the reduction of the fats in compositions for fried products by virtue of the microalgal flour as replacement is consequently demonstrated.

Analysis of the Fried Products Obtained after Cooking

Two series of tests were carried out in order to confirm the reproducibility of the invention.

TABLE 3
First series of tests

| | Control | TEST 1 |
|---|---|---|
| Dry Matter % | 71.9 | 67.5 |
| Fats | 19 | 9 |

| | |
|---|---|
| Fat reduction | 53% |

The analysis of the fat content on the donuts after frying is carried out using a method which makes it possible to assay the total lipids, said method being well known to those skilled in the art and also known as the Soxhlet method.

Lipids are insoluble in water and very soluble in organic solvents, such as hexane. Most methods for assaying lipids exploit these physical properties to extract the lipids from foods for the purpose of measuring their concentration. The Soxhlet method is the reference method used to determine the fat in foods. It is a gravimetric method, since the sample is weighed at the beginning and the fat is weighed at the end of the extraction.

The principle is simple: the product is hydrolyzed using hot hydrochloric acid, then a step of precipitating the total lipids is carried out by cooling.

The lipids are then separated by filtration, dried and isolated by extraction with hexane, before being quantified by gravimetric analysis.

TABLE 4
Second series of tests

| | Control | TEST 2 |
|---|---|---|
| Dry Matter % | 70.2 | 66.8 |
| Fats | 13.9 | 6.8 |

| | |
|---|---|
| Fat reduction | 51% |

The analyses of the fat contents in the final product show results that are slightly different according to the two series of tests, but the level of fat reduction obtained in the donuts containing microalgal flour remains the same: the two series make it possible to obtain a reduction on the fried product of 50% with regard to the fat. Very precisely 53% and 51% reduction, respectively, for the first and second series of tests.

The weight of the products was also determined before and after cooking, and the donuts containing microalgal flour are lighter than the control donuts after they have been fried. It thus appears that they lose more water than they take up oil during frying, contrary to the control donuts which took up more oil after cooking. This is very surprising since normally in products of this type the water lost is replaced by a greater oil uptake.

Thus, the use of microalgal flour in fried products and as a replacement for the fat conventionally used goes against the preconceptions of the prior art.

Thus, the advantage of the invention is also demonstrated by a smaller oil uptake by the donuts containing microalgal flour during the step of cooking by frying.

In addition, this decrease in the level of oil absorption could also have a positive impact on the production cost of the donuts according to the invention.

Analysis and Comparison of the Fat Content on the Composition for Fried Products and on the Fried Products

TABLE 5

| | Control | TEST |
|---|---|---|
| Fat on composition before cooking (%) | 7 | 2.7 |
| Fat on cooked product (1^{st} series of tests) | 19 | 9 |
| (%) | | |
| Fat on cooked product (2^{nd} series of tests) | 13.9 | 6.8 |
| (%) | | |
| Difference in fat between cooked product | 12 | 6.3 |
| and composition before cooking (1^{st} series of | | |
| tests) (%) | | |
| Difference in fat between cooked product | 6.9 | 4.1 |
| and composition before cooking (2^{nd} series | | |
| of tests) (%) | | |

The table above makes it possible to have an idea with regard to the difference in fat between the product cooked by frying and the composition before cooking. This difference in fact makes it possible to quantify the amount taken up by the frying step, both on the control but also on the test and in the two series carried out.

In terms of the control, this difference, which can also be described as fat gain, is 12% for the first series of tests and 6.9% for the second.

For the donuts containing microalgal flour according to the invention, this fat gain is respectively only 6.3% for the first series of tests and 4.1% for the second.

Thus, as previously explained, the donuts containing microalgal flour have a lower oil uptake during the cooking phase then the donuts produced according to a standard composition, free of microalgal flour.

Once again, the advantage of the invention is demonstrated.

### Example 4

### Sensory Analysis of the Fried Products of Donut Type Obtained According to Example 3

14 individuals participated in the sensory evaluation of the fried products of donut type obtained according to the previous example.

The sensory analysis related both to a visual evaluation of the products, but also to an organoleptic evaluation (texture, taste, etc.).

Regarding the visual appearance, the color of the control donut is similar to that of the donut containing microalgal flour according to the invention.

The only visual difference noted for 9 individuals of the jury is that the control donuts appear to have a more matte appearance. This is very probably linked to the fact that they absorb the oil. The donuts containing microalgal flour according to the invention were noted as being slightly shinier at the surface. This could be explained by the fact that they take up less oil during cooking. As a result, the oil appears to form a slight external film coating giving them this slightly shiny appearance.

This particularity could, from the industrial point of view, perhaps make it possible to do away with the glazing step and thus further contribute to reducing the production costs while at the same time also reducing the calorie content (no glazing meaning no sugar at the surface and thus a reduced calorie content in the donut containing microalgal flour and not having undergone a final step of glazing with sugar).

Still from a visual point of view, the appearance of the crumbs is identical with regard to the two products The crumb has a uniform appearance and appears to be very supple and nice and tight. From an organoleptic point of view, the two types of donuts were tasted blind by the panel. Their taste was judged to be very satisfactory and pleasant. No difference in terms of texture, moistness or taste was demonstrated. The two donuts were judged to have a supple, moist and melt-in-the-mouth texture

The donuts containing microalgal flour were however judged to be less greasy in the mouth. This correlates with the objective sought.

Thus, it is perfectly possible to replace the fats of vegetable and/or animal origin conventionally used in the production of fried products of donut type by a microalgal flour in order to significantly reduce the fat content in the compositions and also in the final fried products, without having an impact on the supple, moist and melt-in-the-mouth texture thereof, while at the same time improving both the nutritional profile and also the visual appearance.

The advantage of the present invention is thus demonstrated.

### Example 5

### Other Compositions for Fried Products of Donut Type Which are Low Fat According to the Invention

Other compositions for a fried product according to the invention containing microalgal flour were prepared.

The batch milled at 85%, of example 1, was used in said recipes.

The fat replacement is as described above in the description: 100 parts of fat normally used, of vegetable and/or animal origin, are replaced by a mixture of 25 parts of microalgal flour and 75 parts of water.

The recipes are given in table 2 below.

There were no modifications in the recipe in terms of the preparation method.

Compositions:

TABLE 6

| | | | TEST 1 | | TEST 2 | |
|---|---|---|---|---|---|---|
| | CONTROL | | (saccharose) | | (Allulose) | |
| | g | % | g | % | g | % |
| Wheat flour | 1000.0 | 50 | 1000.0 | 50 | 970.0 | 48.5 |
| Saccharose (sucrose) | 125.0 | 6.2 | 125 | 6.2 | — | — |
| Allulose | — | — | — | — | 155 | 7.7 |
| Microalgal flour | — | — | 25 | 1.2 | 25 | 1.2 |
| Whole egg powder | 50.0 | 2.5 | 50.0 | 2.5 | 50.0 | 2.5 |
| Skimmed milk powder | 30.0 | 1.5 | 30.0 | 1.5 | 30.0 | 1.5 |
| Chemical yeast (raising powder) Volcano | 7.5 | 0.4 | 7.5 | 0.4 | 7.5 | 0.4 |
| Ascorbic acid | 0.2 | 0.0 | 0.2 | 0.0 | 0.2 | 0.0 |
| Salt | 10.0 | 0.5 | 10 | 0.5 | 10.0 | 0.5 |
| Bread improvers | 7.7 | 0.4 | 7.7 | 0.4 | 7.7 | 0.4 |
| Vanilla flavoring | 20.0 | 1 | 20.0 | 1 | 20.0 | 1 |
| Pressed fresh yeast | 70.0 | 3.5 | 70.0 | 3.5 | 70.0 | 3.5 |
| Fats Biscuitine 500 | 100 | 5 | — | — | — | — |
| Water at 32° C. | 580.0 | 29 | 655.00 | 32.7 | 655.0 | 32.7 |
| | 2000.4 | 100 | 2000.4 | 100 | 2000.4 | 100% |

The preparation protocol is identical to that indicated in the preceding example 3.

The three donuts obtained according to the recipes above, the control recipe and those using the microalgal flour as a replacement for all the fats of shortening type according to the present invention with saccharose or alluose as sugar were tasted by a panel of tasters, and the taste thereof was judged to be very satisfactory and pleasant. The texture thereof was noted as being supple, moist and melt-in-the-mouth.

It is therefore entirely possible to envision definitively eliminating fats of vegetable and/or animal origin from the formula of fried products without having an impact on either the production or the final organoleptic properties thereof.

The advantage of the present invention is thus demonstrated by the numerous examples above.

1. A fried product obtained from a composition for a fried product comprising flour, yeast, microalgal flour and a drinkable liquid.

2. The fried product according to claim 1, wherein the composition comprises a sweetening substance.

3. The fried product according to claim 2, wherein the sweetening substance includes up to 20% of at least one of saccharose, allulose and/or any mixtures thereof, where percentages are expressed relative to the total weight of the composition.

4. The fried product according to claim 1, wherein the composition for a fried product comprises up to 80%, flour, the percentages are expressed relative to the total weight of the composition.

5. The fried product according to claim 1, wherein the product does not contain gluten.

6. The fried product according to claim 1, wherein the composition comprises up to 30% eggs or egg products, these percentages expressed relative to the total weight of the composition.

7. The fried product according to claim 1, wherein the composition comprises up to 30% of milk derivatives, these percentages being expressed relative to the total weight of the composition.

8. The fried product according to claim 1, wherein the fats of vegetable origin and/or animal origin present in the composition have been partially or totally replaced by the microalgal flour.

9. The fried product according to claim 8, wherein all fat has been replaced with microalgal flour.

10. The fried product according to claim 1, wherein the fat content of the composition for a fried product is reduced by 30 in comparison with the fat content contained in the composition for a fried product free of microalgal flour, the percentage being expressed relative to the total weight of the composition.

11. The fried product according to claim 1, wherein 100 parts of fat normally used, of vegetable and/or animal origin, in the composition for a fried product are replaced by a mixture of 25 parts of microalgal flour and 75 parts of a drinkable liquid.

12. The fried product according to claim 1, wherein the drinkable liquid is water, it being possible for said water to be spring water, mineral water, water that is naturally sparkling or sparkling through the addition of carbon dioxide, or still.

13. The fried product according to claim 1, wherein the composition for a fried product comprises from 0.5% to 20% of microalgal flour these percentages being expressed relative to the total weight of the composition.

14. The fried product according to claim 1, wherein the sum of the components consisting of the microalgal flour and the drinkable liquid in the composition for the fried product represents 25% by weight of the composition.

15. The fried product according to claim 1, wherein the microalgal flour is a flour of microalgae of the Chlorella genus.

16. The fried product according to claim 1, wherein the microalgal flour contains at least 12% by dry weight of lipids.

17. The fried product according to claim 1, wherein the fat content of which is reduced by at least 30% relative to the fried product obtained according to a standard composition, free of microalgal flour.

18. The fried product according to claim 1, wherein the composition is sweet and contains saccharose, allulose and/or any mixtures thereof.

19. The fried product according to claim 1, wherein it is dusted with sugar, glazed, iced with melted sugar, covered with a sweet and flavored topping, and/or filled with a confectioner's custard, with savory or sweet and/or flavored Chantilly cream, with a ganache, with a fatty filling.

20. The use of a microalgal flour as fat replacer in the preparation of a fried product according to claim 1.

21. A method for preparing a fried product according to claim 1, wherein the flour, the eggs or egg products, the yeast and the microalgal flour are mixed with a drinkable liquid, before cooking.

22. The method for preparing a fried product as claimed in claim 21,
mixing the flour, the eggs or egg products, the yeast and the microalgal flour with a drinkable liquid, preferentially water,
fermenting this mixture,
shaping said mixture into dough balls,
cooking said dough balls in a bath of hot oil between 150° C. and 200° C. for a period ranging from 30 seconds to 3 minutes for each side.

23. The method according to claim 21, further comprising providing fried products having a total fat content reduced by at least 30%, relative to the fried product obtained according to a composition free of microalgal flour.

24. A fried product having a reduced fat content comprising a composition containing flour, yeast, between 0.5% and 20% microalgal flour, and a drinkable liquid.
